(19) United States
(12) Patent Application Publication
(10) Pub. No.: US 2023/0315815 A1
(43) Pub. Date: Oct. 5, 2023

(54) SECURE AUDIO PLAYBACK

(71) Applicant: NUANCE COMMUNICATIONS, INC., Burlington, MA (US)

(72) Inventors: William F. GANONG, III, Brookline, MA (US); Ljubomir MILANOVIC, Vienna (AT); Uwe JOST, Groton, MA (US); Dushyant SHARMA, Mountain House, CA (US); Patrick NAYLOR, Reading (GB)

(73) Assignee: NUANCE COMMUNICATIONS, INC., Burlington, MA (US)

(21) Appl. No.: 17/713,837

(22) Filed: Apr. 5, 2022

(51) Int. Cl. G06F 21/10; H04L 9/32; H04L 9/40

(52) U.S. Cl. CPC G06F 21/10; H04L 9/3231; H04L 63/0435; H04L 63/0442; G06F 2221/0724

(57) ABSTRACT

A method includes: providing a workstation having a playback app configured for audio playback; providing a decryption module having a decryption functionality communicatively connected to the playback app; encrypting, by a server using an encryption key associated with the decryption module, audio data; and decrypting, using the decryption module, the encrypted audio data. The decryption module having the decryption functionality is provided as part of the playback app, as part of firmware of a headphone, or as part of a phone app. The method can additionally include: i) authenticating, using a voice biometric authentication module, a transcriber; ii) enabling decryption by the decryption module only upon input of a decode PIN by the transcriber; and iii) a) modifying the audio data to spatialize speech component and noise component of the audio data at different angles using head-related transfer function (HRTF) filtering, and b) playing back the audio data binaurally.

### BACKGROUND OF THE DISCLOSURE

### 1. Field of the Disclosure

The present disclosure relates to systems and methods for playback of audio, and relates more particularly to enhanced security for remote playback of audio transmitted from a server.

### 2. Description of the Related Art

As speech transcription demands increase in modern digital environments, more attention has been focused on the goal of ensuring the security of the audio data involved in the speech transcription. For a company utilizing human transcribers who are outside the company's digital firewall, these human transcribers present a security vulnerability, e.g., for an unauthorized person or entity seeking to access the audio data being handled by the transcribers. As an example, in the field of medical information, which is subject to a multitude of privacy regulations, unauthorized access to any audio data being handled by a transcriber working for a company presents a real possibility of reputational damage and/or regulatory repercussion for the company. Unfortunately, current state of the art doesn't provide any protection particular to transcription against an attack on a transcriber's workstation. Therefore, there is need for a system and a method to achieve increased security against an attack on a transcriber's workstation.

### SUMMARY OF THE DISCLOSURE

According to an example embodiment of the present disclosure, a system and a method are provided for security against an attack on a remote device by an attacker who has remotely taken control of a remote device, e.g., on playback of audio transmitted from a server to a transcriber working on a PC that has been taken over by a remote attacker who is attempting to recover the audio.

In another example embodiment of the present disclosure, the audio sent from a server to a transcriber's workstation can be encrypted using a key which is specific to the transcriber.

In another example embodiment of the present disclosure, audio decryption can be allowed to proceed only if i) voice biometric authentication of the transcriber has been satisfied (which authentication can be required periodically), and/or ii) the transcriber types into the playback app a decode PIN which is visually displayed in the playback app.

In another example embodiment of the present disclosure, the audio (e.g., speech) is played back binaurally and the signal is modified to use the “spatial release from masking” effect, so that the transcriber can still hear the audio to be transcribed, but an attacker with access to one channel would get a signal corrupted with noise.

In another example embodiment of the present disclosure, the firmware of a headphone worn by a transcriber contains a public key and a private key pair, the server encrypts the audio using the headphone's public key, and the headphone decrypts the audio using its corresponding private key.

In yet another example embodiment of the present disclosure, the decryption functionality is contained in a phone app, and the encrypted audio sent by the server is decrypted by the phone app.

In yet another example embodiment of the present disclosure, the transcriber's workstation can be embodied as a firmware-based device that can encrypt any output, e.g., transcriber's typed output.

### BRIEF DESCRIPTION OF THE FIGURES

FIG. 1a illustrates the architecture of an example embodiment of a system for providing increased security against an attack on a transcriber's workstation.

FIG. 1b illustrates the architecture of another example embodiment of a system for providing increased security against an attack on a transcriber's workstation.

FIG. 2 illustrates the architecture of yet another example embodiment of a system for providing increased security against an attack on a transcriber's workstation.

FIG. 3 illustrates a different signal flow in comparison to the signal flow shown in FIG. 2 for the architecture of the example embodiment of a system for providing increased security against an attack on a transcriber's workstation.

FIG. 4 illustrates a specific example embodiment of the architecture of the system illustrated in FIG. 1a.

### DETAILED DESCRIPTION

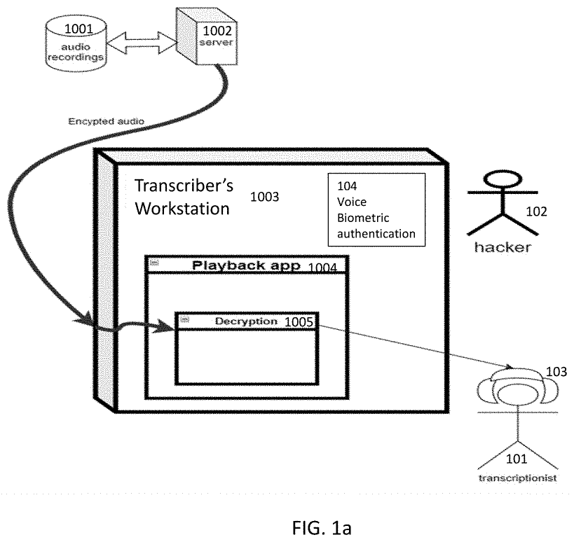

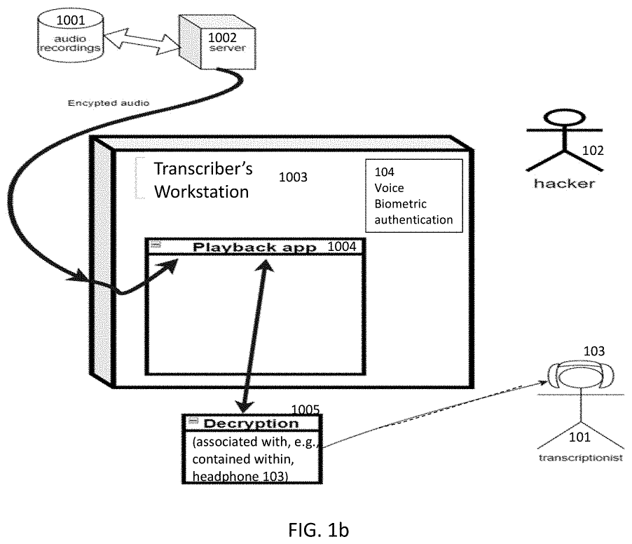

FIG. 1a illustrates the architecture of an example embodiment of a system for providing increased security against an attack on a transcriber's workstation. As shown in FIG. 1a, audio recordings, e.g., stored in a storage medium 1001, are accessible to a server 102, which is in turn communicatively connected to a transcriber's workstation 1003. The transcriber's workstation 1003 refers to any computer-processor-based device that can be embodied as, e.g., a personal computer (PC), a tablet, or a smartphone, each having a visual display screen and a keyboard (either touchscreen or physical). In this example embodiment, the transcriber's workstation 1003 contains a playback app 1004, which in turn contains a decryption functionality 1005 (which can be embodied in a module implemented as a software and/or hardware). The playback app 1004 of the transcriber's workstation 1003 can be connected to a headphone 103 worn by a transcriptionist (transcriber) 101, although this isn't required.

As illustrated in FIG. 1a, let's assume a hacker (attacker) 102 is present, and that the hacker (attacker) 102 has gained remote control of the transcriber's workstation 1003. The goal of the example embodiment of the system and method illustrated in FIG. 1a is to prevent the hacker 102 from recovering the audio information from the playback app 1004. For this purpose, the audio sent from the server 1002 to the transcriber's workstation 1003 can be encrypted using a key which is specific to the transcriber. In one example embodiment, a private key known only by the transcriber's device can be used to generate a shared private key, which can be used by the server 1002 to encrypt the audio and subsequently used by the transcriber's workstation for decryption. Alternatively, the server can encrypt the audio using a public key of the transcriber that is known to the server, and subsequent decryption can be performed using the transcriber's private key. Upon receipt of the encrypted audio, the audio is decrypted by the decryption functionality 1005 of the playback app 1004. To provide enhanced security, audio decryption can be allowed to proceed only if i) voice biometric authentication (e.g., using voice biometric authentication module 104) of the transcriber has been satisfied (which authentication can be required periodically), and/or ii) the transcriber types into the playback app 1004 a decode PIN which is visually displayed in the playback app 1004. Additional security can be provided by requiring: i) the playback of the audio via the headphone 103; and/or ii) turning off any analog/digital recording devices on the transcriber's workstation 1003.

In addition to the above, an additional layer of security can be provided by playing back the audio (e.g., speech) binaurally and modify the signal to use the “spatial release from masking” effect, so that the transcriber can still hear the audio to be transcribed, but an attacker with access to one channel would get a signal corrupted with noise. More specifically, the technique is to spatialize the speech at one angle using Head-related Transfer Function (HRTF) filtering, and spatialize the noise at a different angle. When played back in mono, each channel sounds like noisy speech (unintelligible if the noise is strong enough), but when played back binaurally, the spatial separation can be exploited by the listener to separate the target speech from the noise. The intelligibility degradation may not be large enough to prevent an attacker from correctly hearing most of the words, but it would, at least, make it difficult for the attacker to build a voiceprint from any audio recording the attacker could make. Incidentally, in the case of using binaural presentation for a recording with multiple speakers, it may be beneficial to also spatialize the different speakers (e.g., as determined by automatic speech recognition (ASR) diarization) differently, in order to ease the transcribers' task.

FIG. 1b illustrates the architecture of another example embodiment of a system for providing increased security against an attack on a transcriber's workstation. The system configuration shown in FIG. 1b differs from the configuration shown in FIG. 1a in that: i) the decryption functionality 1005 is associated with the headphone 103, e.g., contained within the firmware of the headphone 103; and ii) the firmware of the headphone 103 contains a public key and a private key pair. In this example embodiment, the following signal flow occurs: i) the server 1002 encrypts the audio using the headphone's public key; ii) the encrypted audio is sent by the server 1002 to the playback app 1004 in the transcriber's workstation 1003, which in turn transmits the encrypted audio to the headphone 103, and iii) the headphone 103 decrypts the audio using its corresponding private key.

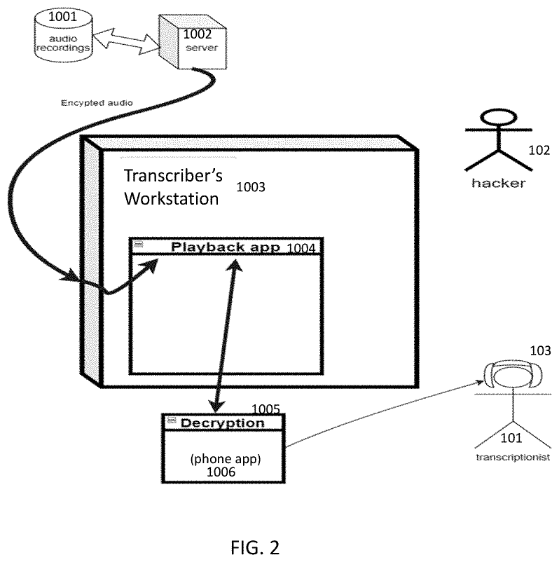

FIG. 2 illustrates the architecture of yet another example embodiment of a system for providing increased security against an attack on a transcriber's workstation. The system configuration shown in FIG. 2 differs from the configuration shown in FIG. 1a in that: i) the decryption functionality 1005 is associated with a phone app 1006, e.g., contained within the phone app 1006; and ii) the decryption functionality 1005 is operationally connected to the remaining portion of the playback app. In this example embodiment, the following example signal flow can occur: i) the server 1002 encrypts the audio using the phone app's public key; ii) the encrypted audio is sent by the server 1002 to the playback app 1004 in the transcriber's workstation 1003, which in turn transmits (e.g., via a local connection such as Bluetooth™) the encrypted audio to the phone app 1006, and iii) the decryption functionality 1005 decrypts the audio using its corresponding private key.

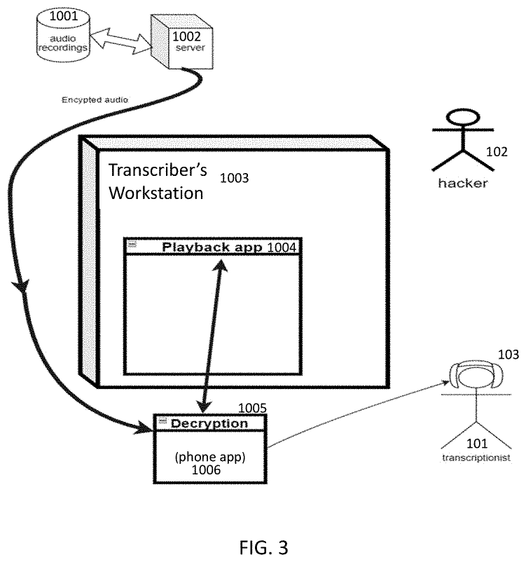

FIG. 3 illustrates a different signal flow in comparison to the signal flow shown in FIG. 2 for the architecture of the example embodiment of a system for providing increased security against an attack on a transcriber's workstation. In FIG. 3, the following signal flow is shown: i) the server 1002 encrypts the audio using the phone app's public key; ii) the encrypted audio is sent by the server 1002 directly to the phone app 1006; and iii) the decryption functionality 1005 decrypts the audio using its corresponding private key.

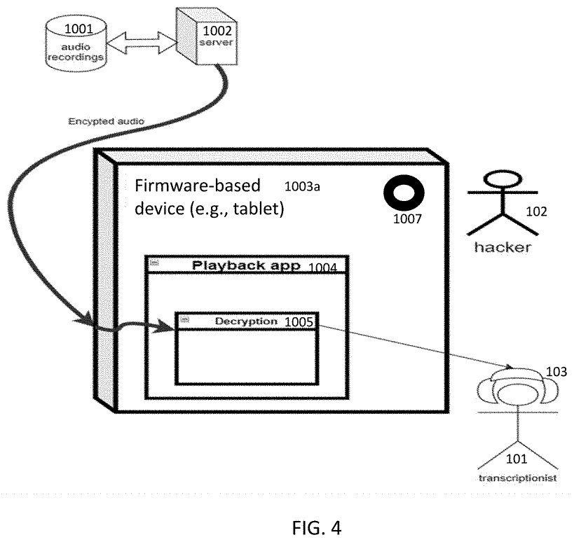

FIG. 4 illustrates a specific example embodiment of the architecture of the system illustrated in FIG. 1a, which specific example embodiment of FIG. 4 shows a firmware-based device 1003a (e.g., a tablet) as an embodiment of the transcriber's workstation. Associated with the firmware on the device 1003a are a private key and a public key pair. The private key is only on the firmware-based device 1003a, and can't be seen by any external entity. The public key specific to the firmware-based device 1003a is known to the server 1002, so the audio sent from the server 1002 to the firmware-based device 1003a can be encrypted using asymmetric encryption, i.e., the server 1002 encrypts the audio using the public key specific to the firmware-based device 1003a. Upon receipt of the encrypted audio, the decryption functionality 1005 of the firmware-based device 1003a decrypts the received audio using the private key of the transcriber's workstation 1003.

As an additional layer of security, e.g., in the system shown in FIG. 4 (as well as in the other example embodiments of the present disclosure), a public key associated with the server 1002 can be sent to the firmware-based device 1003a at the start of each transcription session by the transcriptionist 101. The firmware-based device 1003a can encrypt any output (e.g., transcriptionist's typed output) using the public key associated with the server 1002, and only the server 1002 can decrypt the encoded output from the firmware-based device 1003a. As yet another layer of security, the firmware-based device 1003a can include a camera (e.g., camera 1007 shown in FIG. 4) to bio-authenticate the transcriptionist and/or the ongoing presence of the transcriptionist.

The system and method according to the present disclosure provide a crucial security improvement over a conventional transcription application on a PC. A conventional transcription application on a PC can use, e.g., native capabilities in a browser to decode speech transmitted to the PC via Hypertext Transfer Protocol Secure (HTTPS) or standard system calls. In this case, a remote attacker could run his own app or browser to decode and copy the speech, in a ‘man-in-the-middle’ attack (i.e., the remote attacker would produce an attacker's browser, which looked like a normal, “legitimate” browser, except that the attacker's browser copied information out of the “legitimate” browser into a location the attacker could access). Another possibility is that the remote attacker could add a browser extension, allowing the attacker to copy the decoded audio out. Yet another possibility is that the attacker could copy the decoded speech from the decoded audio buffers.

Example embodiments (e.g., FIGs. 1a and 4) of the system and method according to the present disclosure implement the decryption within the playback application (app) module, thus making it significantly more difficult for the attacker to access the decoded audio. The playback application module can buffer the encrypted audio, e.g., in internal buffers within the playback app module, and decode the encrypted audio into the internal buffers. In order for the remote attacker to have the possibility of gaining access to the audio buffers internal to the app, the remote attacker would need to have “super-user” privileges.

As used in the present disclosure, the terms “transcriber” and “transcriptionist” are intended to encompass a human engaged in a broad range of speech-to-text conversion tasks, e.g., i) verbatim reporting of spoken words, ii) summarizing of spoken statements (e.g., generating a medical report based on patient encounter, work conventionally done by a medical scribe), and iii) editing of computer-controlled, ASR-based draft of text output from speech, e.g., work done by a quality document specialist (QDS).

The present disclosure provides a first example system which includes: a workstation having a playback app configured for audio playback; and a decryption module having a decryption functionality communicatively connected to the playback app, wherein the decryption module is configured to decrypt audio data previously encrypted with an encryption key associated with the decryption module.

The present disclosure provides a second example system based on the above-discussed first example system, in which second example system the encrypted audio data is i) encrypted by a server using one of a private key or a public key associated with the decryption module, and ii) transmitted for decryption by the decryption module.

The present disclosure provides a third example system based on the above-discussed second example system, in which third example system at least one of: a) a first private key associated with the decryption module is used to generate a second private key, wherein the second private key is used by the server to encrypt the audio data, and the second private key is used by the decryption module for decryption of the audio data; and b) the public key associated with the decryption module is used by the server to encrypt the audio data, and the first private key associated with the decryption module is used for decryption of the audio data.

The present disclosure provides a fourth example system based on the above-discussed second example system, in which fourth example system the decryption module having the decryption functionality is part of the playback app.

The present disclosure provides a fifth example system based on the above-discussed fourth example system, in which fifth example system at least one of: i) the system further comprises a voice biometric authentication module configured to authenticate a transcriber; ii) decryption by the decryption module is enabled only upon input of a decode PIN by the transcriber; and iii) the system is configured to a) modify the audio data to spatialize speech component of the audio data at a specified first angle using head-related transfer function (HRTF) filtering and spatialize noise component of the audio data at a specified second angle, and b) play back the audio data binaurally.

The present disclosure provides a sixth example system based on the above-discussed second example system, in which sixth example system the decryption module having the decryption functionality is part of firmware of a headphone configured to be worn by a transcriber.

The present disclosure provides a seventh example system based on the above-discussed second example system, in which seventh example system the decryption module having the decryption functionality is part of a phone app.

The present disclosure provides an eighth example system based on the above-discussed seventh example system, in which eighth example system one of: i) the encrypted audio data is directly transmitted from the server to the phone app; and ii) the encrypted audio data from the server is relayed by the playback app to the phone app.

The present disclosure provides a ninth example system based on the above-discussed second example system, in which ninth example system the workstation is a firmware-based tablet.

The present disclosure provides a tenth example system based on the above-discussed ninth example system, in which tenth example system a public key associated with the server is sent to the firmware-based tablet, and output of the firmware-based tablet is encrypted using the public key associated with the server.

The present disclosure provides a first example method which includes: providing a workstation having a playback app configured for audio playback; providing a decryption module having a decryption functionality communicatively connected to the playback app; encrypting, using an encryption key associated with the decryption module, audio data; and decrypting, using the decryption module, the encrypted audio data.

The present disclosure provides a second example method based on the above-discussed first example method, in which second example method the encrypted audio data is i) encrypted by a server using one of a private key or a public key associated with the decryption module, and ii) transmitted for decryption by the decryption module.

The present disclosure provides a third example method based on the above-discussed second example method, in which third example method at least one of: a) a first private key associated with the decryption module is used to generate a second private key, wherein the second private key is used by the server to encrypt the audio data, and the second private key is used by the decryption module for decryption of the audio data; and b) the public key associated with the decryption module is used by the server to encrypt the audio data, and the first private key associated with the decryption module is used for decryption of the audio data.

The present disclosure provides a fourth example method based on the above-discussed second example method, in which fourth example method the decryption module having the decryption functionality is provided as part of the playback app.

The present disclosure provides a fifth example method based on the above-discussed fourth example method, which fifth example method further includes at least one of: i) authenticating, using a voice biometric authentication module, a transcriber; ii) enabling decryption by the decryption module only upon input of a decode PIN by the transcriber; and iii) a) modifying the audio data to spatialize speech component of the audio data at a specified first angle using head-related transfer function (HRTF) filtering and spatialize noise component of the audio data at a specified second angle, and b) playing back the audio data binaurally.

The present disclosure provides a sixth example method based on the above-discussed second example method, in which sixth example method the decryption module having the decryption functionality is provided as part of firmware of a headphone configured to be worn by a transcriber.

The present disclosure provides a seventh example method based on the above-discussed second example method, which seventh example method the decryption module having the decryption functionality is provided as part of a phone app.

The present disclosure provides an eight example method based on the above-discussed seventh example method, in which eighth example method one of: i) the encrypted audio data is directly transmitted from the server to the phone app; and ii) the encrypted audio data from the server is relayed by the playback app to the phone app.

The present disclosure provides a ninth example method based on the above-discussed second example method, in which ninth example method the workstation is configured as a firmware-based tablet.

The present disclosure provides a tenth example method based on the above-discussed ninth example method, which tenth example method further includes: sending, by the server, a public key associated with the server to the firmware-based tablet; and encrypting, by the firmware-based tablet using the public key associated with the server, output of the firmware-based tablet.

1. A system for securing playback of audio data, comprising:
a workstation having a playback application configured for audio playback; and
a decryption module having a decryption functionality communicatively connected to the playback application, wherein the decryption module is configured to decrypt audio data previously encrypted with an encryption key associated with the decryption module,
wherein the system is configured to:
modify the audio data to spatialize a speech component of the audio data at a first angle using head-related transfer function (HRTF) filtering and to spatialize a noise component of the audio data at a second angle, wherein the first angle is different from the second angle; and
play the audio data binaurally.

2. The system according to claim 1, wherein the encrypted audio data is i) encrypted by a server using one of a private key or a public key associated with the decryption module, and ii) transmitted for decryption by the decryption module.

3. The system according to claim 2, wherein the system is configured to perform one of:
a) use the private key associated with the decryption module to generate a shared private key, wherein the shared private key is used by the server to encrypt the audio data, and the shared private key is used by the decryption module for decryption of the audio data; and
b) use, by the server, the public key associated with the decryption module to encrypt the audio data, wherein the private key associated with the decryption module is used for decryption of the audio data.

4. The system according to claim 1, wherein the decryption module having the decryption functionality is part of the playback application.

5. The system according to claim 1, wherein decryption by the decryption module is enabled only upon one or more of (i) authentication of a transcriber by a voice biometric authentication module, and (ii) an input of a decode personal identification number (PIN) by the transcriber.

6. The system according to claim 1, wherein the decryption module having the decryption functionality is part of firmware of a headphone configured to be worn by a transcriber.

7. The system according to claim 1, wherein the decryption module having the decryption functionality is part of a phone application.

8. The system according to claim 7, wherein the system is configured to perform one of:
i) transmit the encrypted audio data directly from a server to the phone application; and
ii) relay the encrypted audio data from the server via the playback application to the phone application.

9. The system according to claim 1, wherein the audio data comprises a recording with a plurality of speakers, wherein the system is configured to spatialize each of the plurality of speakers differently.

10. The system according to claim 1, wherein the workstation is a firmware-based tablet, wherein a public key associated with a server is sent to the firmware-based tablet, and output of the firmware-based tablet is encrypted using the public key associated with the server.

11. A method for securing playback of audio data, comprising:
receiving, from a server, the audio data for playback by a playback application;
modifying the audio data to spatialize a speech component of the audio data at a first angle using head-related transfer function (HRTF) filtering and to spatialize a noise component of the audio data at a second angle, wherein the first angle is different from the second angle; and
playing, by the playback application, the audio data binaurally.

12. The method according to claim 11, wherein the audio data is i) encrypted by the server using one of a private key or a public key associated with a decryption module communicatively connected to the playback application and having a decryption functionality, and ii) transmitted for decryption by the decryption module.

13. The method according to claim 12, wherein the method is configured to perform one of:
a) use the private key associated with the decryption module to generate a shared private key, wherein the shared private key is used by the server to encrypt the audio data, and the shared private key is used by the decryption module for decryption of the audio data; and
b) use by the server, the public key associated with the decryption module to encrypt the audio data, wherein the private key associated with the decryption module is used for decryption of the audio data.

14. The method according to claim 12, wherein the decryption module having the decryption functionality is part of the playback application.

15. The method according to claim 12, further comprising enabling decryption by the decryption module only upon one or more of (i) authentication of a transcriber by a voice biometric authentication module, and (ii) an input of a decode personal identification number (PIN) by the transcriber.

16. The method according to claim 12, wherein the decryption module having the decryption functionality is as part of firmware of a headphone configured to be worn by a transcriber.

17. The method according to claim 12, wherein the decryption module having the decryption functionality is part of a phone application.

18. The method according to claim 17, further comprising one of:
i) directly receiving the encrypted audio data from the server to the phone application; and
ii) relaying the encrypted audio data from the server via the playback application to the phone application.

19. The method according to claim 11, wherein the audio data comprises a recording with a plurality of speakers, the method further comprising spatializing each of the plurality of speakers differently.

20. The method according to claim 11, wherein the audio data comprises encrypted audio, the method further comprising:
buffering the encrypted audio in one or more internal buffers within the playback application; and
decoding the encrypted audio into the one or more internal buffers.
